(19) United States
(12) Patent Application Publication
(10) Pub. No.: US 2008/0267480 A1
(43) Pub. Date: Oct. 30, 2008

(54) Iterative Image Reconstruction of a Moving Object From Projection Data

(75) Inventors: Tim Nielsen, Hamburg (DE); Michael Grass, Buchholz in der Nordheide (DE); Andy Ziegler, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/097,544

(22) PCT Filed: Dec. 8, 2006
(86) PCT No.: PCT/IB2006/054700

§ 371 Date: Jun. 16, 2008

(30) Foreign Application Priority Data
Dec. 19, 2005 (EP) 05112356.0

(51) Int. Cl. G06T 11/00

(52) U.S. Cl. 382/131

(57) ABSTRACT

Iterative methods for reconstructing an image sequence of a moving object based on projection data usually require a high computationally effort. According to embodiments of the present invention there is provided such a method wherein a first image representing the object at a first phase is used as an initial image for iteratively reconstructing a second image at a second phase. A first gating function is assigned to the first phase, a second gating function is assigned to the second phase. When executing a first iteration for reconstructing the second image only projection data corresponding to a non-overlapping part of the two gating functions are used. For executing further iterations the amount of projection data corresponding to the overlapping part of the two gating functions may be gradually increased. Therefore, for all further but the last iteration the computationally effort is significantly reduced. However, this low computationally expense has no negative impact on the quality of the finally reconstructed second image because the method benefits from the fact that the first image was used as the initial image for iteratively reconstructing the second image.

Iterative image reconstruction of a moving object from projection data The present invention relates to the field of three-dimensional imaging. In particular, the present invention relates to a method for an iterative image reconstruction of a moving object from projection data of the object. The present invention further relates to a data processing device and to a tomography system for reconstructing images of a moving object, to a computer-readable medium and to a program element having instructions for executing the above mentioned reconstruction method.

Computer tomography (CT) is a process for generating three-dimensional images of the internal of an object under examination (object of interest) from a series of X-ray projection data. The reconstruction of CT images from the projection data can be done by applying appropriate algorithms.

One important application in the frame of computer tomography is the so-called cardiac computer tomography which is related to the imaging of a beating heart.

In medical CT highly accurate images with high and isotropic spatial resolution and extremely low noise are required at a minimum of patient dose. Furthermore, CT image reconstruction must be computationally efficient to perform in real time. This is can be achieved by using image reconstruction algorithms based on filtered backprojection (FBP) in two or three dimensions or on Fourier reconstruction approaches.

By contrast to these analytic methods there are iterative reconstruction algorithms that view the reconstruction problem from a numerical point of view. They seek to invert the System matrix or to maximize the probability of the measurement by iterating between spatial domain and projection domain. Their key advantage is the ability to be able to operate at reduced patient dose by accurately modeling the quantum statistics of the scan. These techniques, however, require up to a few hundred iterations to converge sufficiently. Each iteration consists at least of one reprojection and one backprojection of the image and the raw data, respectively. Consequently, one iteration is computationally at least as expensive as two FBP reconstructions.

An iterative approach for reconstructing cyclically moving objects based on projection data is described in the article “Gated cardiac scanning using limited-angle image reconstruction technique and information in the neighbouring phases”, written by K. C. Tam, B. Macdonald and V. Perez-Mendez. This article was published in IEEE Transactions on nuclear Science 31, 562-565 (1983). Therein, it is described that the results for iterative reconstruction can be improved by using the scans of a neighbouring portion of the cardiac cycle as a first estimate of the missing scans in the phase of interest when initializing the iterations. However, when applying this iterative approach in medical praxis it is still a computational challenge to accomplish such an image reconstruction within real time.

There may be a need for an improved iterative image reconstruction of a moving object based on projection data of the object.

This need may be met by a method for reconstructing images of a moving object from projection data of the object as set forth in claim 1. The projection data include a plurality of projection data recorded at a plurality of phase points of the object and at a plurality of different projection angles of the object. To each phase there is assigned a gating function defining weighting factors for using different projection data for the image reconstruction. The described method comprises the steps of (a) loading data signals representing a first image of a first phase of the object as an initial image into a data processor, wherein there is assigned a first gating function to the first phase; (b) using the first image as an initial image for iteratively reconstructing a second image of a second phase of the object, wherein there is assigned a second gating function to the second phase; (c) comparing the first and the second gating function with each other; and (d) executing a first iteration of a reconstruction algorithm, wherein only projection data corresponding to a non-overlapping part of the two gating functions are used.

It may be seen as a gist of the described method that a reduced dataset is used for reconstructing the second image. The image representing this slightly different phase may itself be reconstructed by the described method wherein a further from a previous reconstruction well known image has been used as an initial image. However, at least one image representing the start image of a sequence of images showing the moving object under examination has to be reconstructed without any image information of a previous status of the object.

The described method may significantly increase the reconstruction speed. In particular, the reconstruction speed may be enhanced if the reconstructed phases of the moving object are in close temporal distance. Therefore, the computation time for executing an iterative reconstruction method for various phases of a moving object is dramatically reduced.

By repetitive accomplishing the described method for subsequent phases a complete movie of the moving object can be obtained, wherein the computationally expenses can be kept within acceptable limits.

It has to be pointed out that the term “moving object” is not limited to a physical movement of an object. In this context the term “moving object” may mean all kinds of temporary variations of optical values of an object. Such a variation may be a change of gray scale values which occurs e.g. when a contrast agent flows through an organ representing a moving object under examination.

According to an exemplary embodiment of the invention the method further comprises the steps of executing a second iteration and further iterations, wherein the amount of projection data corresponding to the overlapping part of the two gating functions is gradually increased. This may provide the advantage that even though for reconstructing the second image a more or less reduced projection data set is employed for most of the corresponding iterations, the quality of the resulting image is not deteriorated. The good image quality is based on the fact that the already reconstructed first image of the moving object showing the object at the first phase is used as an initial image which is similar to the second image in particular when the two phase points are within a close temporal distance.

In other words, only for reconstructing the first image of a multi-phase sequence, acquired data corresponding to the full first gating function has to be used for all iterations of the iterative reconstruction algorithm. For all images at later phases the data corresponding to the full gating functions are used only for the last iteration. For all previous iterations data corresponding to more or less reduced gating functions are used. This may advantageously increase the reconstruction speed for a complete movie of the object under examination at a variety of different phases.

According to a further exemplary embodiment of the invention the overlap between the first gating function and the second gating function referred to the area of a single gating function is bigger than 90% and preferably bigger than 95%. In this context it has to be noted that the higher the overlap between the cardiac gating functions of neighboring phases is, the higher the speed up of the reconstruction effort is. Therefore, such a big overlap may enhance the reconstruction speed significantly.

According to a further exemplary embodiment of the invention a plurality of images of a periodically moving object is reconstructed. Since a periodically or cyclically moving object reaches a certain state at least once within one periodic cycle, this provides the possibility that the object may be recorded repeatedly at the same phase point, wherein different recordings are carried out at phase points corresponding to different cycles. This may allow for an improved image quality because a plurality of projection data recorded effectively at the same phase point might be obtained and these projection data may be used in combination for an image reconstruction of the periodically moving object at this phase point.

In this context it should be noted that the term “phase point” relates to definite time points of a cyclic or periodic motion of the object under examination. In order to be precise the term “phase” is used for a certain motional state of the object. Therefore, for cardiac imaging the term “phase” may correspond to the systole or to the diastole of a beating heart. By contrast thereto, the term “phase point” is used for time points at which the object under examination has been existent in a certain phase.

The periodically moving object may be e.g. the chest or more particular the lung of a patient. In this context the gating functions are called pulmonary gating functions. Using such pulmonary gating functions may allow reconstructing an image of a lung wherein only data referring to a determined point in a breathing cycle of a patient is used for generating the image. By putting a plurality of reconstructed lung images obtained at different phase points in a sequence a complete movie of the breathing lung may be produced.

According to a further exemplary embodiment of the invention the periodically moving object is a beating heart, the gating functions are cardiac gating functions, and the projection data of the object include cardiac computer tomography data and simultaneously measured electrocardiogram data. Therefore, a reconstruction of selected images of the cardiac cycle may be carried out allowing a detailed investigation of cardio dynamics, i.e. the course of heart chamber contractions and heart chamber expansions.

By repetitive accomplishing the described method for subsequent phases of the cardiac cycle a movie showing the complete cycle of the beating heart can be reconstructed. Such a movie typically comprises images of 20 different phases. This may allow e.g. for a study of the wall motion of the periodically beating heat.

According to a further exemplary embodiment of the invention the cardiac gating functions are generated with reference to the R-R interval of the beating heart. This may allow for a precise gating of the data acquisition because this interval defines the cycle duration of the quasi periodic heart motion. The R waves are usually the most prominent waves in the course of an electrocardiogram. Therefore, the R waves are detectable easily and accurately.

According to a further exemplary embodiment of the invention the reconstruction algorithm is a Maximum Likelihood algorithm. The Maximum Likelihood algorithm may have the advantage that a high signal to noise ratio may be obtained even for noisy data signals. In this context a noisy data signal is a projection data signal containing only a small number of detector counts for each detector element of a two dimensional spatial resolving detector array which is usually used as the radiation detector for computer tomography. Using noisy data signals may have the advantage that the object under examination can be exposed to a reduced radiation dose only. This is advantageously in particular when human beings are investigated.

In this context it has to be noted that also other reconstruction algorithms may be used e.g. algebraic reconstruction technique (ART).

The above mentioned need may further be met by a data processing device. The data processing device comprises a memory for storing projection data signals of a moving object, wherein the projection data include a plurality of projection data recorded at a plurality of phases of the object and at a plurality of different projection angles of the object and wherein to each phase there is assigned a gating function defining weighting factors for using different projection data for the image reconstruction. The data processing device further comprises a data processor for producing images representing different phases of the moving object based on the projection data signals of the object. The data processor is adapted for performing the following operation: (a) loading data signals representing a first image of a first phase of the moving object as an initial image into a data processor, wherein there is assigned a first gating function to the first phase; (b) using the first image as an initial image for iteratively reconstructing a second image of a second phase of the object, wherein there is assigned a second gating function to the second phase; (c) comparing the first and the second gating function with each other; and (d) executing a first iteration of a reconstruction algorithm, wherein only projection data corresponding to a non-overlapping part of the two gating functions are used.

According to an exemplary embodiment of the invention the data processor is further adapted for carrying out the operation of executing a second iteration and further iterations, wherein the amount of projection data corresponding to the overlapping part of the two gating functions is gradually increased.

When using the data processing device for producing a movie of the object under examination showing images at a variety of different phases this may provide the advantage that only for the first image the full first gating function has to be used. For all images at later phases only projection data corresponding to reduced gating functions have to be used such that the overall reconstruction effort may be reduced significantly.

The above mentioned need may further be met by a tomography system for reconstructing images of a moving object. The tomography system comprises a radiation source adapted for emitting a radiation beam; a radiation detector adapted for detecting the radiation beam after the beam has passed the object; a memory for storing projection data signals of the moving object obtained by the radiation detector, wherein the projection data include a plurality of projection data recorded at a plurality of phases of the object and at a plurality of different projection angles of the object and wherein to each phase there is assigned a gating function defining weighting factors for using different projection data for the image reconstruction. The tomography system further comprises a data processor for producing images representing different phases of the moving object based on the projection data signals of the object. The data processor is adapted for performing the following operation: (a) loading data signals representing a first image of a first phase of the object as an initial image into a data processor, wherein there is assigned a first gating function to the first phase; (b) using the first image as an initial image for iteratively reconstructing a second image of a second phase of the object, wherein there is assigned a second gating function to the second phase; (c) comparing the first and the second gating function with each other; and (d) executing a first iteration of a reconstruction algorithm, wherein only projection data corresponding to a non-overlapping part of the two gating functions are used.

The radiation source may be a conventional X-ray source, which can either emit a polychromatic or a monochromatic radiation. The radiation detector can be formed of a single radiation sensor, a plurality of radiation sensors or a sensor array.

The tomography system may be applied as a material testing apparatus, a medical application apparatus or any other apparatus for measuring three-dimensional images of a moving object, wherein the images are taken at different phases of the movement of the object. The tomography system may also be a coherent scatter computed tomography apparatus, a positron emission tomography apparatus or a single photon emission computer tomography apparatus. Anyway, it should be clear that the present invention is not limited to X-ray computer tomography.

According to an exemplary embodiment of the invention the radiation beam is a cone-beam. By contrast to the so called fan-beam geometry in cone-beam geometry the radiation source is adapted for emitting a radiation beam comprising a two dimensional cross section which may allow a much faster data acquisition. Since the data processor is adapted for carrying out an iterative reconstruction algorithm like a Maximum Likelihood algorithm, the described tomography system advantageously may be capable of producing images which do not suffer from cone-beam artifacts. Therefore, high quality images may be produced within both (a) a short data acquisition time wherein the moving object under examination is liable to a radiation exposure and (b) a comparable short calculating time wherein the images are reconstructed.

According to a further exemplary embodiment of the invention the tomography system further comprises a monitor for estimating the motion of the moving object. This may allow a precise a synchronization between the movement of the object and the utilization of the recorded projection data for reconstruction imaged showing different phases of the object.

According to a further exemplary embodiment of the invention the monitor is an apparatus for monitoring the periodic movement of a beating heart, in particular the monitor is an electrocardiograph. In case the moving object under examination is a beating heart this may advantageously allow for a precise determination of cardiac cycle. Therefore, precise gating functions, i.e. cardiac gating functions may be obtained allowing a precise and fast image reconstruction for neighboring phases of the beating heart.

The above mentioned need may further be met by a computer-readable medium on which there is stored a computer program for reconstructing images of a moving object from projection data of the object, wherein the projection data include a plurality of projection data recorded at a plurality of phases of the object and at a plurality of different projection angles of the object and wherein to each phase there is assigned a gating function defining weighting factors for using different projection data for the image reconstruction. The computer program, when being executed by a processor, is adapted for performing an operation comprising steps of exemplary embodiments of the above described method.

The above mentioned need may further be met by a program element for reconstructing images of a moving object from projection data of the object, wherein the projection data include a plurality of projection data recorded at a plurality of phases of the object and at a plurality of different projection angles of the object and wherein to each phase there is assigned a gating function defining weighting factors for using different projection data for the image reconstruction. The program element, when being executed by a processor, is adapted for performing an operation comprising steps of exemplary embodiments of the above described method.

The program element may be written in any suitable programming language, such as, for example, C++ and may be stored on a computer-readable medium, such as a CD-ROM. Also, the computer program may be available from a network, such as the World Wide Web, from which it may be downloaded into image processing units or processors, or any suitable computer.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 shows a simplified schematic representation of a computer tomography (CT) system.

FIG. 2 shows an exemplary schematic electrocardiograph recording for associating a cardiac state with a time point.

FIG. 3 shows a diagram depicting gating functions for two phase points of a cardiac cycle.

FIG. 4 shows a flow chart on a method for reconstructing a three-dimensional image sequence of a moving object.

FIG. 5 shows an image processing device for executing an exemplary embodiment of a method in accordance with the present invention.

FIG. 6 shows reconstruction results obtained with the method according to a preferred embodiment of the invention.

### DETAILED DESCRIPTION OF THE DRAWINGS

The illustration in the drawing is schematically. It is noted that in different drawings, similar or identical elements are provided with same reference signs or with reference signs which are different from each other only within the first digit.

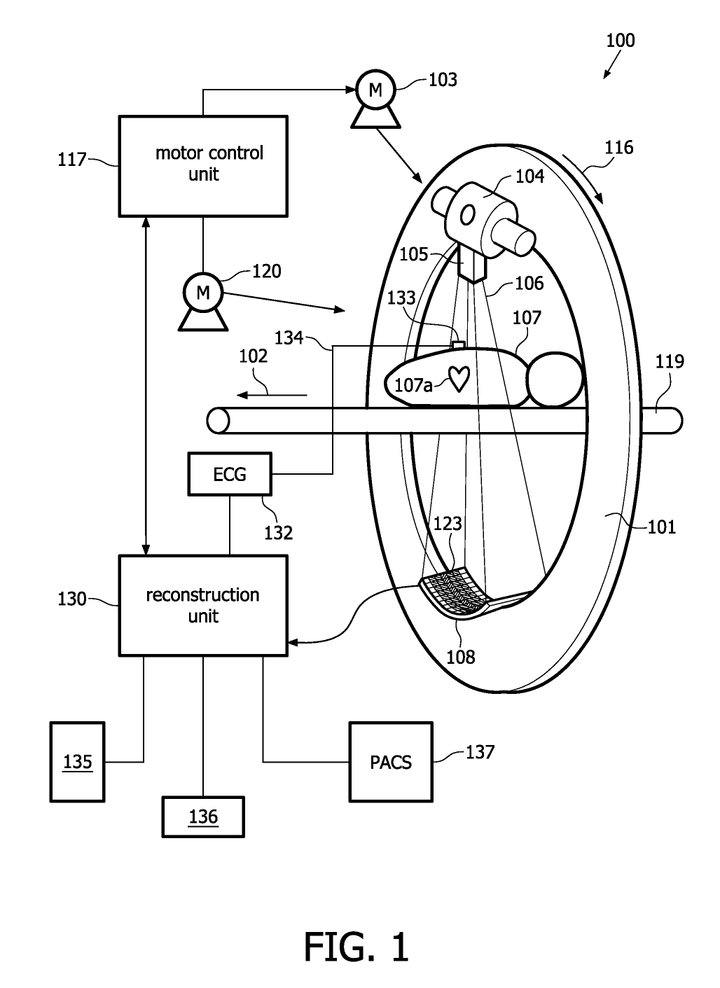

FIG. 1 shows a computer tomography apparatus 100 which is also called a CT scanner. The CT scanner 100 comprises a gantry 101, which is rotatable around a rotational axis 102. The gantry 101 is driven by means of a motor 103. Reference numeral 104 designates a source of radiation such as an X-ray source, which may emit polychromatic or alternatively monochromatic radiation.

Reference numeral 105 designates an aperture system which forms the radiation beam emitted from the radiation source 104 into a cone-shaped radiation beam 106. The cone-shaped beam 106 is directed such that it penetrates an object of interest. The object of interest is the heart 107a of a patient 107. The patient 107 is positioned on an operation table 119. The patient's heart 107a is arranged in the center of the gantry 101 which represents the examination region of the CT scanner 100. After penetrating the object of interest the beam 106 impinges onto a radiation detector 108.

As may be taken from FIG. 1, the detector 108 is arranged on the gantry 101 opposite to the source of radiation 104 such that the surface of the detector 108 is covered by the cone beam 106. The detector 108 comprises a plurality of detector elements 123 wherein each is capable of detecting X-rays which have been scattered by or passed through the patient 107.

During scanning the object of interest 107, the source of radiation 104, the aperture system 105 and the detector 108 are rotated together with the gantry 101 in a rotation direction indicated by an arrow 116. For rotation of the gantry 101, the motor 103 is connected to a motor control unit 117 which itself is connected to a reconstruction or unit 130 (which might also be denoted as a calculation or a determination unit).

The computer tomography apparatus 100 captures multi-cycle cardiac computer tomography data of the heart 107a. Thereby, the gantry 101 rotates and in the same time the operation table 119 is shifted linearly parallel to the rotational axis 102 such that a helical scan of the heart 107a is performed. The linear displacement of the operation table 119 is carried out by a motor 120 which is also connected to the motor control unit 117.

It should be noted that in all of the described cases it is also possible to perform a circular scan, where there is no displacement in a direction parallel to the rotational axis 102, but only the rotation of the gantry 101 around the rotational axis 102. Thereby, slices of the heart 107a may be measured with high accuracy.

During the preferred helical scan performed by the radiation source 104 and the radiation detector 108, the heart 107a may beat a plurality of times. Simultaneously, an electrocardiogram is measured by the electrocardiograph 132. The electrocardiograph 132 monitors the cardiac cycle of the patient's heart 107a. In order to measure electric signal originating from the beating heart 107a a sensor 133 is provided which is coupled to the electrocardiograph 132 via a cable 133.

After having acquired the cardiac computer tomography data and the gating electrocardiogram data, these data are transferred to the reconstruction unit 130 which determines images of the beating heart at different phase points of the heart cycle.

A cardiac phase point is a temporal position within the cardiac cycle, and is preferably defined relative to the cardiac cycle duration, e.g. as a percentage position within the cardiac cycle, to approximately compensate for variations in the cardiac cycle duration. Such variations in the cardiac cycle duration, i.e. the patient's pulse rate, can occur due to stress resulting from the CT examination, medical conditions such as heart arrhythmia, or the like.

In order to observe the reconstructed images a display 135 is provided, which is coupled to the reconstruction unit 130. Additionally, the images may also be printed out by a printer 136 which may also be coupled to the reconstruction unit 130. Further, the reconstruction unit 130 may also be coupled to a picture archiving and communications system (PACS) 137.

It should be noted that display 135, printer 136 and/or other devices supplied within the CT scanner 100 may be local to the computer tomography apparatus 100. Alternatively, these components may be remote from the CT scanner 100, such as elsewhere within an institution or hospital, or in an entirely different location linked to the CT scanner 100 via one or more configurable networks, such as the Internet, virtual private networks and so forth.

Further, it shall be emphasized that, as an alternative to the cone-beam configuration depicted in FIG. 1, the invention can be realized by a fan-beam configuration. By contrast to cone-beam geometry, wherein the X-ray paths to various elements 123 of the detector array are not generally parallel, in fan-beam geometry there is generated a plurality of substantial parallel fan-beams of radiation, wherein each parallel beam is detected by a corresponding row or rows of detector elements.

Regardless of the detailed geometry of the X-ray beam and the detector array, the X-ray detectors operate in known ways to convert X-ray that have been traversed the object under examination into electrical signals indicative of X-ray absorption between the X-ray tube and the detectors.

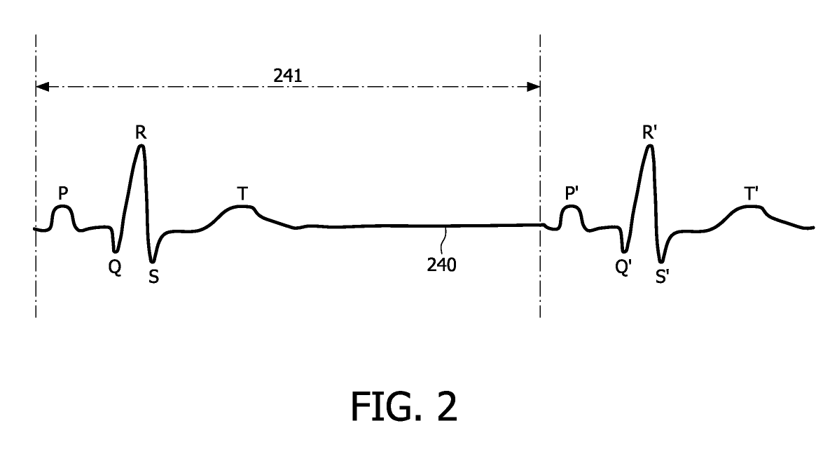

With reference to FIG. 2, there is depicted a typical electrocardiogram (ECG) signal 240 corresponding to electrical potentials generated by the heart 107a on the surface of the body of the patient 107. The ECG is recorded using the electrocardiograph 132. The ECG signal 240 typically includes several identifiable wave-forms which can be associated with the motion of the cardiac organ or portions thereof. The most prominent wave-forms are the P, Q, R, S, and T waves indicated in FIG. 2. The P wave is caused by the spread of depolarization through the atria, followed by a contraction of the atria. Shortly after the P wave, the Q, the R and the S wave pattern appear due to depolarization of the ventricles. The T wave indicates re-polarization of the ventricles, and occurs slightly before relaxation.

The ECG signal 240 is quasi-periodic with a cardiac cycle 241, depicted in FIG. 2 together with a cycle repetition including the wave-forms P′, Q′, R′, S′, and T′ corresponding to wave-forms P, Q, R, S, and T. The cardiac cycle repeats in a quasi-periodic manner which however varies from perfect periodicity due to influences such as physical exertion, emotional stress, the presence of certain drugs, medical conditions such as heart arrhythmia, and the like.

Although cardiac cycle monitoring using an electrocardiograph is described herein, other methods for monitoring the cardiac cycle and detecting a selected cardiac state can also be used. For example, a phonocardiogram (not shown) detects acoustical signals associated with the heart cycling, and can be used to monitor the cardiac cycle and detect a cardiac phase corresponding to a selected positional state of the heart. Alternatively, the cardiac positional state can be directly measured, e.g. using concurrent ultrasound imaging, or can be extracted from the CT data itself e.g. by applying iterative reconstruction algorithms. Furthermore, one can also monitor the cardiac cycle with optical means e.g. by employing so called finger clips.

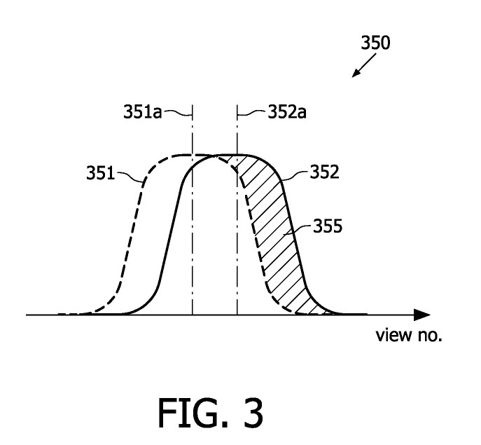

FIG. 3 shows a diagram 350 depicting a first gating function 351 and a second gating function 352. On the x-axis there is plotted the view number of the CT scanner, i.e. data taken at different projection angles while the radiation source 104 and the radiation detector 108 performed a helical scan around the heart 107a. Since the traveling speed of the radiation source 104 and the radiation detector 108 are usually constant, the x-axis could also be denoted as a time axis. The gating functions represent weighting factors in the range between zero and one. The first gating function 351 represents weighting factors corresponding to a first phase point 351a of a cardiac cycle. The second gating function 352 represents weighting factors corresponding to a second phase point 352a of the cardiac cycle. A weighting factor zero means that the acquired projection data are completely ignored for the image reconstruction of the heart. A weighting factor one means that the corresponding projection data are used for the image reconstruction with a maximum weight.

It has to be pointed out that in FIG. 3 the two gating functions 351 and 352 are depicted in the region around the two phase points 351a and 352a only. As has already been pointed out above, for cardiac CT the beating hart is typically imaged at 20 different phase points. Within these 20 phase points the gating functions corresponding to two subsequent phase points show the same behavior as the two gating functions 351 and 352 depicted in FIG. 3.

As can be seen from FIG. 3 the two phase points 351a and 352a are located in close temporal distance from each other such that the two gating functions 351 and 352 exhibit a strong overlap. According to the method for reconstructing images of a moving object described herein a second image of the second phase corresponding to the phase point 352a of the moving object is iteratively reconstructed by using the known first image of the first phase corresponding to phase point 351a as an initial image. For a first iteration of a reconstruction algorithm only projection data corresponding to a non-overlapping part 355 of the two gating functions are used.

For further iterations of the reconstruction algorithm the amount of projection data corresponding to the overlapping part of the two gating functions is gradually increased. This may provide the advantage that only for the first image of a movie of a multi-phase sequence data corresponding to a full gating function have to be used. For all images at later phases only for the last iteration the data corresponding to the full gating functions are used. For all previous iterations only data corresponding to more or less reduced gating functions are used.

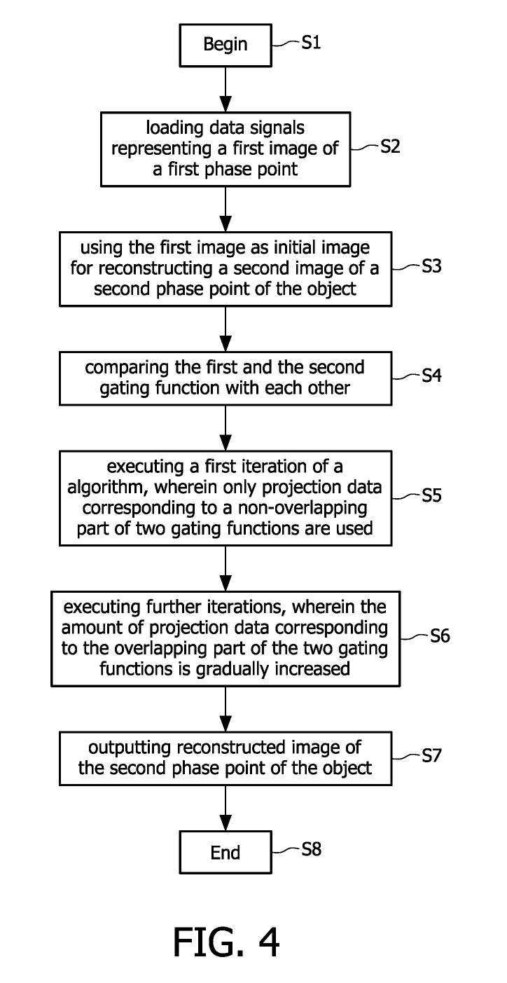

FIG. 4 shows a flow chart of an exemplary method for reconstructing a three-dimensional image sequence of a moving object. The method starts with a step S1.

In step S2, data signals representing a first image reconstructed at a first phase of the object are loaded as an initial image into a data processor. These data signals may be obtained by applying a known reconstruction method to measured projection data corresponding to a first cardiac gating function. The gating function represents weighting factors for the full set of acquired projection data.

Then, in step S3, the first image is used as an initial image for iteratively reconstructing a second image of a second phase of the object. For reconstructing the second image a second gating function representing weighting factors for the full set of acquired projection data is used.

Then, in step S4, the first and the second gating functions are compared with each other. Thereby, an overlapping part and a non overlapping part of the two gating functions is determined. Precisely, the non overlapping part is defined by the positive portion of the difference between the gating function corresponding to phase 2 and the gating function corresponding to phase 1.

Then, in step S5, a first iteration of a reconstruction algorithm is executed, wherein only projection data corresponding to the non-overlapping part of the two gating functions are used. Since for the first iteration only a reduced amount of projection data is employed, the computationally effort for this first iteration is significantly reduced compared to state of the art iterative reconstruction algorithms.

Then, in step S6, a second iteration and further iterations are executed, wherein the amount of projection data corresponding to the overlapping part of the two gating functions is gradually increased. Therefore, also for all further but the last iteration, the computationally effort is reduced. However, this has no negative impact on the quality of the finally reconstructed second image since the method benefits from the fact that the first image was used as the initial image for iteratively reconstructing the second image.

Then, in step S7, the iteratively reconstructed image of the second phase is outputted on a display, on a printer or on a PACS. It has to be noted that in particular when a sequence of at least three images of the beating heart is reconstructed the second image may also be temporally stored in a memory. After finishing the reconstruction of other phases a complete movie of the periodically beating heart may be outputted.

Finally, the method ends with a step S8.

In this context it has to be noted, that it is clear for those skilled in the art that the above described method could easily be utilized for reconstructing a third image and further images of a moving object. For iteratively reconstructing the third image at a third phase the previous reconstructed second image may be used as the initial image for the iterative reconstruction of the third image. In general, the previously reconstructed image could be used for an iterative reconstruction of the next image showing the object under examination at a next phase.

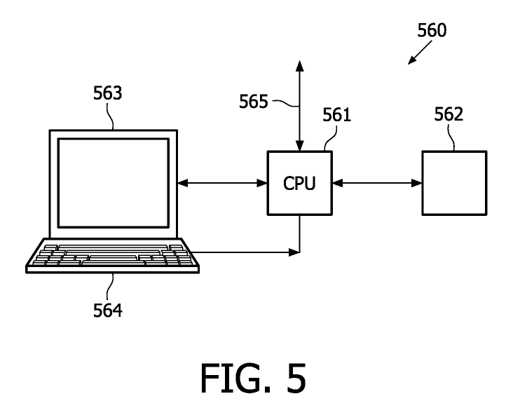

FIG. 5 depicts an exemplary embodiment of a data processing device 560 according to the present invention for executing an exemplary embodiment of a method in accordance with the present invention. The data processing device 560 comprises a central processing unit (CPU) or image processor 561. The image processor 561 is connected to a memory 562 for temporally storing acquired projection and electrocardiogram data and for temporally storing reconstructed images depicting the object under examination at various phase points. Via a bus system 565 the image processor 561 is connected to a plurality of input/output network or diagnosis devices, such as a CT scanner and an electrocardiograph. Furthermore, the image processor 561 is connected to a display device 563, for example a computer monitor, for displaying information or one or more images iteratively reconstructed by the image processor 561. An operator or user may interact with the image processor 561 via a keyboard 564 and/or any other output devices, which are not depicted in FIG. 5.

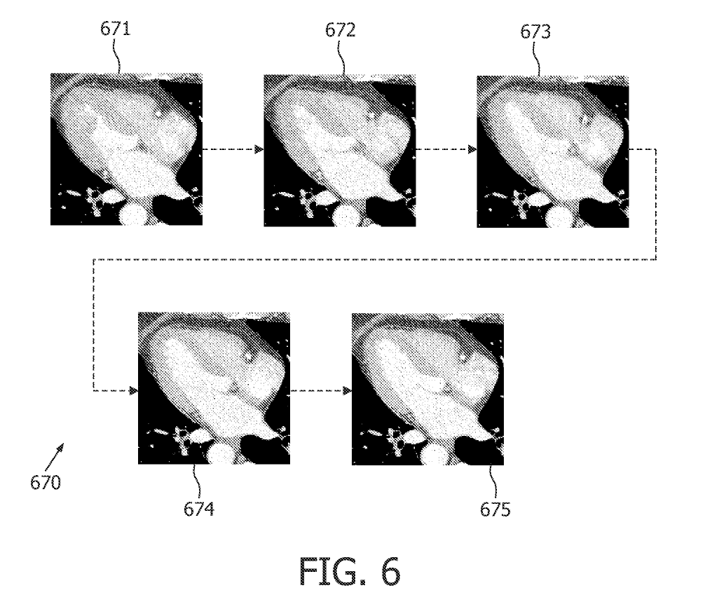

FIG. 6 shows a reconstructed cardiac image sequence 670 obtained with the method according to a preferred embodiment of the invention. The image sequence 670 is reconstructed on the basis of clinical CT projection data measured with a CT scanner shown in FIG. 1. The image sequence 670, which comprises five images 671, 672, 673, 674 and 675, shows the evolution of the beating heart from systole to mid-diastole.

The image sequence 670 was obtained with a reconstruction speed which was faster by a factor of three compared to the reconstruction speed which is achievable by using state of the art iterative reconstruction algorithm.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

In order to recapitulate the above described embodiments of the present invention one can state:

Iterative methods for reconstructing an image sequence of a moving object based on projection data usually require a high computationally effort. According to embodiments of the present invention there is provided such a method wherein a first image representing the object at a first phase is used as an initial image for iteratively reconstructing a second image at a second phase. A first gating function is assigned to the first phase, a second gating function is assigned to the second phase. When executing a first iteration for reconstructing the second image only projection data corresponding to a non-overlapping part of the two gating functions are used. For executing further iterations the amount of projection data corresponding to the overlapping part of the two gating functions may by gradually increased. Therefore, for all further but the last iteration the computationally effort is significantly reduced. However, this low computationally expense has no negative impact on the quality of the finally reconstructed second image because the method benefits from the fact that the first image was used as the initial image for iteratively reconstructing the second image.

### LIST OF REFERENCE SIGNS

100 computer tomography apparatus/CT scanner
101 gantry
102 rotational axis
103 motor
104 radiation source
105 aperture system
106 radiation beam
107 patient
107a heart of patient/object of interest/object under examination
108 radiation detector
116 rotation direction
117 motor control unit
119 table
120 motor
123 detector elements
130 reconstruction unit
132 electrocardiograph
133 sensor at patient
134 cable to sensor
135 monitor
136 printer
137 Picture archiving and communication system (PACS)
240 electrocardiogram signal
241 cardiac cycle
350 diagram
351 cardiac gating function 1
351a phase point 1
352 cardiac gating function 2
352a phase point 2
355 non overlapping part, new data
S1 step 1
S2 step 2
S3 step 3
S4 step 4
S5 step 5
S6 step 6
S7 step 7
560 data processing device
561 central processing unit/image processor
562 memory
563 display device
564 keyboard
565 bus system
670 reconstructed cardiac image sequence
671 image no. 1
672 image no. 2
673 image no. 3
674 image no. 4
675 image no. 5

1. A method for reconstructing images of a moving object from projection data of the object, wherein the projection data include a plurality of projection data recorded at a plurality of phases of the object and at a plurality of different projection angles of the object and wherein to each phase there is assigned a gating function defining weighting factors for using different projection data for the image reconstruction, the method comprising the steps of:
loading data signals representing a first image of a first phase of the object as an initial image into a data processor, wherein there is assigned a first gating function to the first phase;
using the first image as an initial image for iteratively reconstructing a second image of a second phase of the object, wherein there is assigned a second gating function to the second phase;
comparing the first and the second gating function with each other; and
executing a first iteration of a reconstruction algorithm, wherein only projection data corresponding to a non-overlapping part of the two gating functions are used.

2. The method according to claim 1, further comprising the steps of:
executing a second iteration and further iterations, wherein the amount of projection data corresponding to the overlapping part of the two gating functions is gradually increased.

3. The method according to claim 1, wherein
the overlap between the first gating function and the second gating function referred to the area of a single gating function is bigger than 90% and preferably bigger than 95%.

4. The method according to claim 1, wherein
images of a periodically moving object are reconstructed.

5. The method according to claim 4, wherein
the periodically moving object is a beating heart,
the gating functions are cardiac gating functions, and
the projection data of the object include cardiac computer tomography data and simultaneously measured electrocardiogram data.

6. The method according to claim 5, wherein
the cardiac gating functions are recorded with reference to the R-R interval of the beating heart.

7. The method according to claim 1, wherein
the reconstruction algorithm is a Maximum Likelihood algorithm.

8. The method according to claim 1, wherein
the reconstruction algorithm is the algebraic reconstruction technique (ART).

9. A data processing device, comprising:
a memory for storing projection data signals of a moving object, wherein the projection data include a plurality of projection data recorded at a plurality of phases of the object and at a plurality of different projection angles of the object and wherein to each phase there is assigned a gating function defining weighting factors for using different projection data for the image reconstruction; and
a data processor for producing images representing different phases of the moving object based on the projection data signals of the object, wherein the data processor is adapted for performing the following operation:
loading data signals representing a first image of a first phase of the moving object as an initial image into a data processor, wherein there is assigned a first gating function to the first phase;
using the first image as an initial image for iteratively reconstructing a second image of a second phase of the object, wherein there is assigned a second gating function to the second phase;
comparing the first and the second gating function with each other; and
executing a first iteration of a reconstruction algorithm, wherein only projection data corresponding to a non-overlapping part of the two gating functions are used.

10. The data processing device according to claim 9, wherein the data processor (561) is further adapted for carrying out the following operation:
executing a second iteration and further iterations, wherein the amount of projection data corresponding to the overlapping part of the two gating functions is gradually increased.

11. A tomography system for reconstructing images of a moving object, the tomography system comprising:
a radiation source adapted for emitting a radiation beam;
a radiation detector adapted for detecting the radiation beam after the beam has passed the object;
a memory for storing projection data signals of the moving object obtained by the radiation detector, wherein the projection data include a plurality of projection data recorded at a plurality of phases of the object and at a plurality of different projection angles of the object and wherein to each phase there is assigned a gating function defining weighting factors for using different projection data for the image reconstruction; and
a data processor for producing images representing different phases of the moving object based on the projection data signals of the object, wherein the data processor his adapted for performing the following operation:
loading data signals representing a first image of a first phase of the object as an initial image into a data processor, wherein there is assigned a first gating function to the first phase;
using the first image as an initial image for iteratively reconstructing a second image of a second phase of the object, wherein there is assigned a second gating function to the second phase;
comparing the first and the second gating function with each other; and
executing a first iteration of a reconstruction algorithm, wherein only projection data corresponding to a non-overlapping part of the two gating functions are used.

12. The tomography system according to claim 11, wherein
the radiation beam is a cone-beam.

13. The tomography system according to claim 11, further comprising
a monitor for estimating the motion of the moving object.

14. The tomography system according to claim 13, wherein
the monitor is an apparatus for recording an electrocardiogram.

15. A computer-readable medium on which there is stored a computer program for reconstructing images of a moving object from projection data of the object, wherein
the projection data include a plurality of projection data recorded at a plurality of phases of the object and at a plurality of different projection angles of the object and wherein
to each phase there is assigned a gating function defining weighting factors for using different projection data for the image reconstruction, which computer program, when being executed by a processor, is adapted for performing the following operation:
loading data signals representing a first image of a first phase of the object as an initial image into a data processor, wherein there is assigned a first gating function to the first phase;
using the first image as an initial image for iteratively reconstructing a second image of a second phase of the object, wherein there is assigned a second gating function to the second phase;
comparing the first and the second gating function with each other; and
executing a first iteration of a reconstruction algorithm, wherein only projection data corresponding to a non-overlapping part of the two gating functions are used.

16. (canceled)
